(19) United States
(12) Patent Application Publication
(10) Pub. No.: US 2007/0277171 A1
(43) Pub. Date: Nov. 29, 2007

(54) PROGRAM INSTALLATION METHOD AND APPARATUS

(75) Inventor: Hirokazu Oi, Machida-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/696,098

(22) Filed: Apr. 3, 2007

(30) Foreign Application Priority Data
Apr. 11, 2006 (JP) 2006-108805

(51) Int. Cl. G06F 9/445

(52) U.S. Cl. 717/174

(57) ABSTRACT

A first apparatus acquires a first program on the basis of apparatus information of a second apparatus, and installs the first program. The first apparatus also acquires a second program corresponding to the first apparatus, and provides the second apparatus with the second program, which is installed by the second apparatus.

### BACKGROUND OF THE INVENTION

1. Field of the Invention

The present invention relates to a program installation method and apparatus.

2. Description of the Related Art

A system of the related art has been known in which, when an apparatus (called “apparatus B”) is connected to an apparatus (called “apparatus A”), appropriate software, program, or driver is automatically installed into apparatus A, depending on a type and function of the connected apparatus B.

Those known as “plug-and-play” devices are examples of the apparatuses in the above system.

According to Japanese Patent Laid-Open No. 2000-330920, when a peripheral device is connected to an information processing apparatus, software that operates in the combination can automatically be installed or updated.

However, the above technologies of the related art have the following problems.

Specifically, it is common that software is installed or updated not only in so-called “computers” but also in embedded devices. Accordingly, at present, functional enhancement after shipment has become common place. In addition, it is also common that, by connecting two embedded devices without using a personal computer, a service or function is provided. In this case, if apparatus B connected to apparatus A is functionally enhanced, software of apparatus A may not support the functional enhancement. Also, the software of apparatus A may not support bug correction and functional addition in apparatus B.

### SUMMARY OF THE INVENTION

The present invention provides installation of appropriate software into two apparatuses connected to each other.

The present invention also provides a program installation method which includes acquiring a first program by a first apparatus on the basis of apparatus information of a second apparatus; installing the first program into the first apparatus by the first apparatus; acquiring a second program corresponding to the first program by the first apparatus; and, by the first apparatus, providing the second apparatus with a second program that is installed by the second apparatus.

Moreover, the present invention also provides a program installation method which includes acquiring a first program by a third apparatus on the basis of apparatus information of a second apparatus; by the third apparatus, providing a first apparatus with the first program, which is installed into the first apparatus; by the third apparatus, acquiring a second program corresponding to the first program; and, by the third apparatus, providing the first apparatus with the second program, which is installed by the second apparatus.

Furthermore, the present invention also provides a program installation method which includes acquiring a first program by a first apparatus on the basis of a function requested by a second apparatus; installing the first program into the first apparatus by the first apparatus; by the first apparatus, acquiring a second program corresponding to the first program; and, by the first apparatus, providing the second apparatus with the second program, which is installed into the second apparatus by the second program.

Additionally, the present invention also provides a program installation method which includes acquiring a first program by a third apparatus on the basis of a function requested by a second apparatus; by the third apparatus, providing a first apparatus with the first program, which is installed into the first apparatus; by the third apparatus, acquiring a second program corresponding to the first program; and, by the third apparatus, providing the first apparatus with the second program, which is installed by the second apparatus.

Further features and aspects of the present invention will become apparent from the following description of exemplary embodiments with reference to the attached drawings.

### BRIEF DESCRIPTION OF THE DRAWINGS

FIG. 1 is a block diagram showing an example of the configuration of a program installation system.

FIG. 2 is a block diagram showing an example of an internal configuration of the TV shown in FIG. 1.

FIGS. 3A-B are a first flowchart showing an example of a program installation process.

FIGS. 4A-B are a second flowchart showing the example of the program installation process.

FIG. 5 is an illustration of an example of a supported apparatus list.

FIG. 6 is an illustration of an example of a supported apparatus list for each camera shown in FIG. 1.

FIGS. 7A-B are a first flowchart showing an example of a process for installing a program for providing a function.

FIGS. 8A-B are a second flowchart showing the example of the process for installing the program for providing the function.

FIG. 9 is an illustration of an example of a function table.

FIG. 10 is an illustration of an example of a function program table.

FIG. 11 is a flowchart showing an example of an installation process for installing a program.

FIG. 12 is a flowchart showing an example of a first disconnection process.

FIG. 13 is a flowchart showing an example of an apparatus alteration process.

FIG. 14 is a flowchart showing an example of a second disconnection process.

### DESCRIPTION OF THE EMBODIMENTS

Exemplary embodiments of the present invention will now herein be described below with reference to the accompanying drawings.

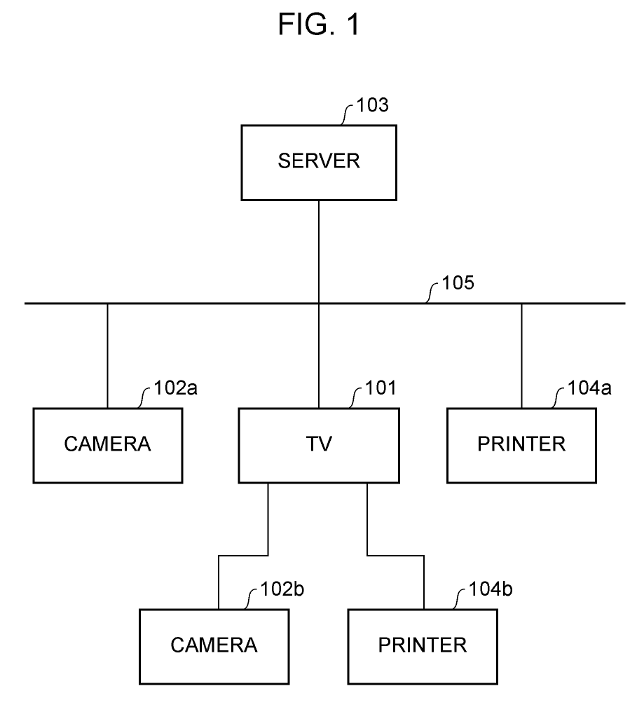

FIG. 1 is a block diagram showing an example of the configuration of a program installation system. This system includes a television (TV) 101, cameras 102a and 102b, a server 103, printers 104a and 104b, and a network 105.

The TV 101 and the cameras 102a and 102b can externally install programs into them, and can execute the programs. Although, in this sense, both may be computers, this embodiment uses the TV 101 and the cameras 102a and 102b for description.

In the server 103, a memory of the like stores a program for the TV 101 and a program for each of the cameras 102a and 102b. Both programs may be stored in a memory or the like of the TV 101 by the TV 101.

The network 105 connects the TV 101, the cameras 102a and 102b, the server 103, and the printers 104a and 104b. The network 105 may be either wired or wireless. The network 105 may be of any type of network capable of performing data communication by logically connecting the TV 101, the cameras 102a and 102b, the server 103, and the printers 104a and 104b.

The TV 101 and the camera 102b may be directly connected to each other without using the network 105. Although various types of interfaces, such as USB (Universal Serial Bus) and IEEE (Institute of Electrical and Electronic Engineers) 1394, are possible for direct connection, it is only required that logical connection be established.

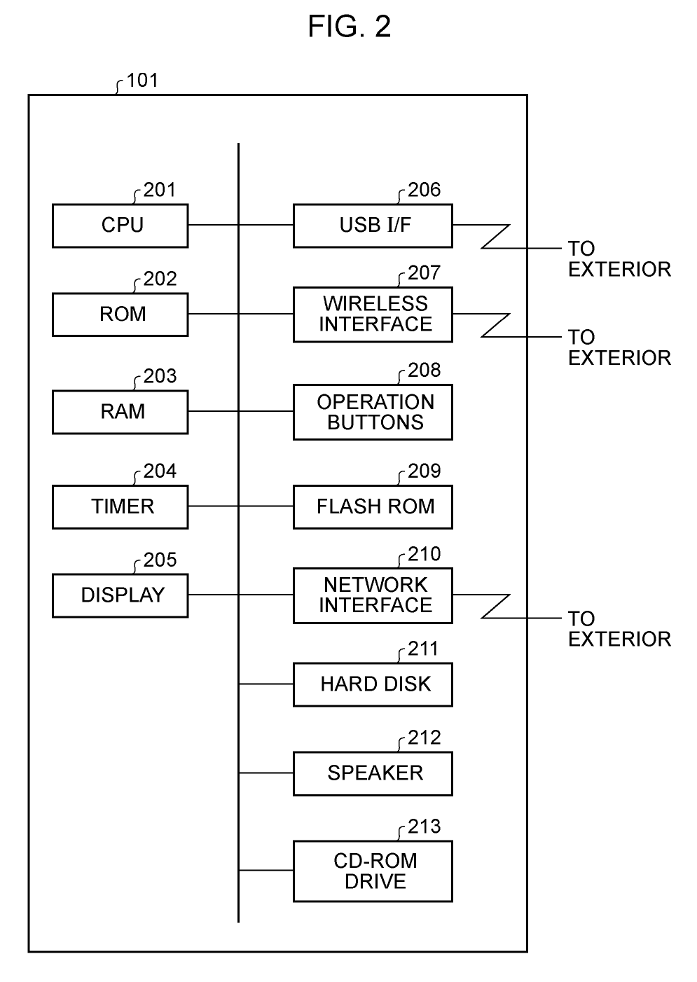

Next, an internal configuration of the TV 101 is described with reference to the block diagram of FIG. 2. FIG. 2 shows an example of the internal configuration of the TV 101.

In FIG. 2, the TV 101 includes a CPU (central processing unit) 201 for controlling the entirety of the TV 101, a ROM (read-only memory) 202 storing various operation programs in readable form, and a RAM (random access memory) 203 for use in temporarily storing values during program operation. In addition, the TV 101 includes a timer 204 for measuring various types of times, a display 205 for displaying a TV screen and various setting menus, etc., by using GUI (graphical user interface) components, a USB interface 206 for connecting to an external apparatus, and a wireless interface 207 for connecting an external apparatus.

The TV 101 includes various types of operation buttons 208, a flash ROM 209 that is a nonvolatile memory for storing various setting data files, and a network interface 210 for connecting to an external apparatus. The TV 101 also includes a hard disk 211 for storing various operation programs and setting data files. The TV 101 also includes a speaker 212 for audio output and a CD-ROM (compact-disc read-only memory) drive 213 for reading a program and data from a CD-ROM medium.

FIG. 2 shows the internal configuration of the TV 101. However, the elements shown in FIG. 2 are common in a common computer. Each of the cameras 102a and 102b, the server 103, and the printers 104a and 104b includes elements similar to those shown in FIG. 2 although it includes a characteristic element. An internal configuration of each apparatus is not shown since it is similar to that shown in FIG. 2.

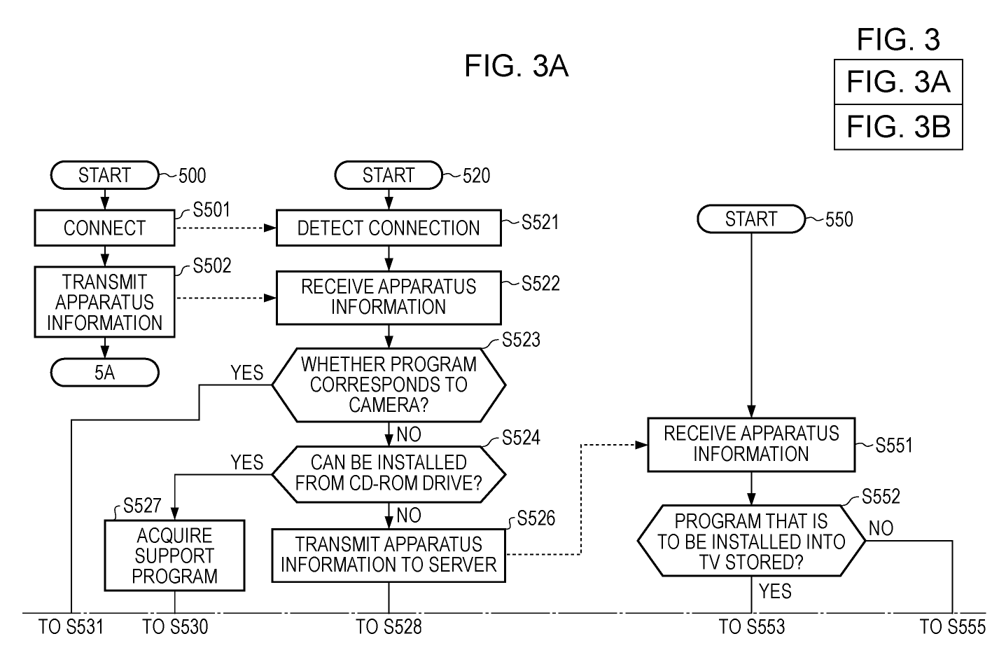

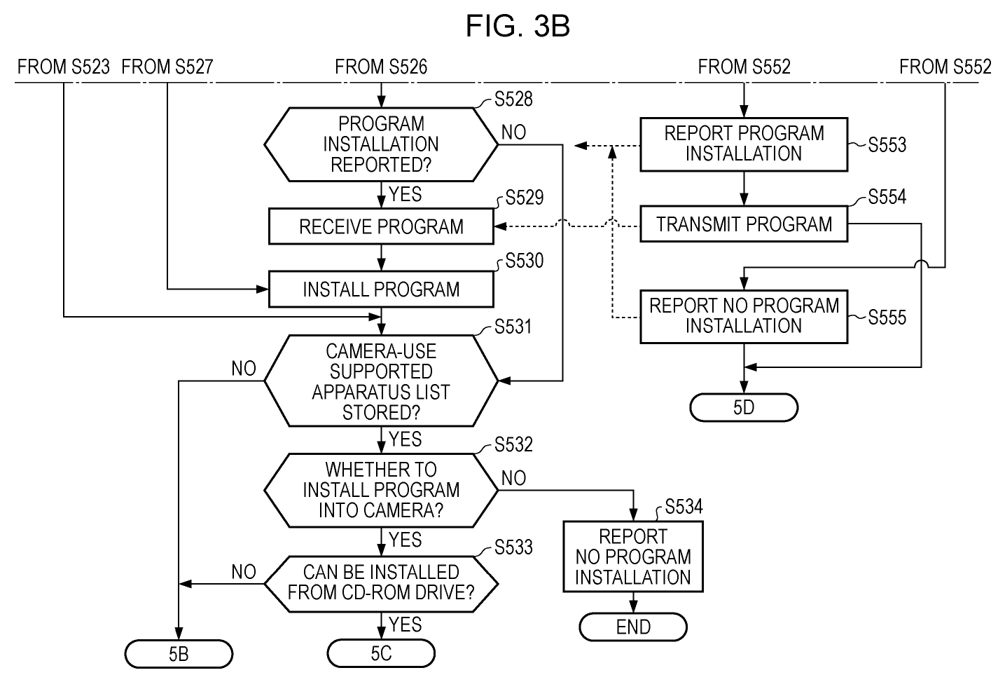

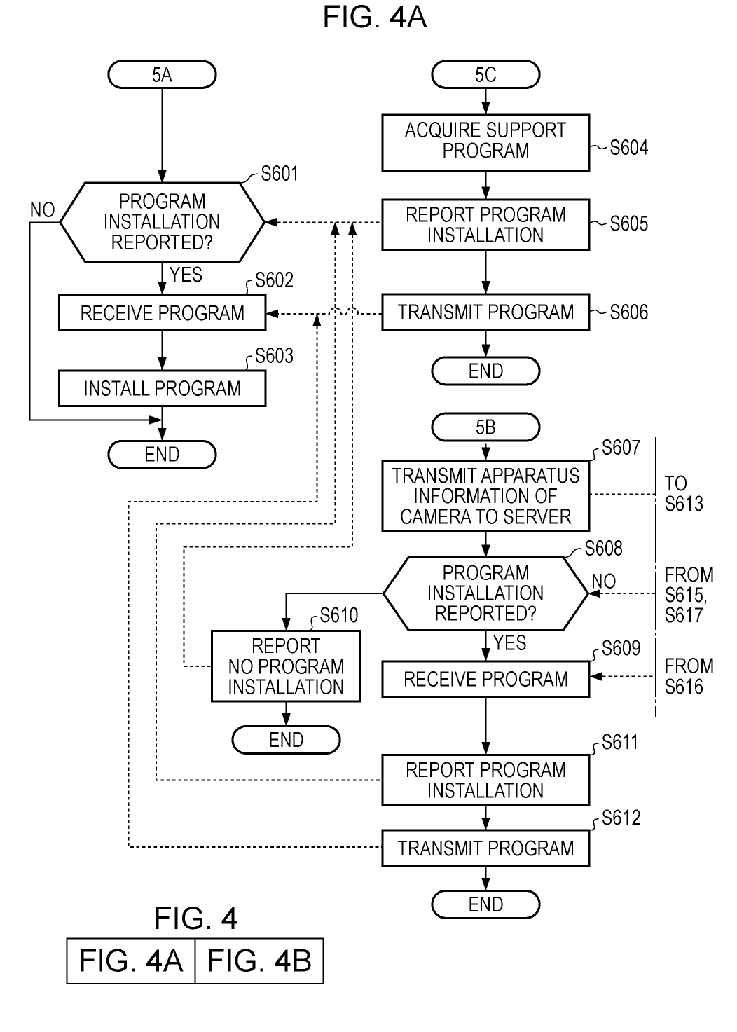

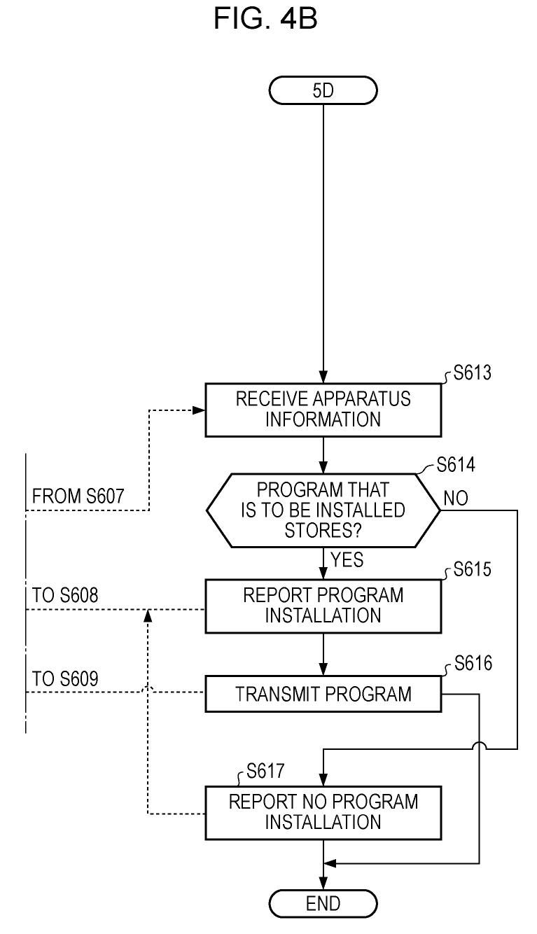

Next, program installation processes for the TV 101, each of the cameras 102a and 102b, and the server 103 are described below with reference to the flowcharts shown in FIGS. 3A-B and 4A-B. FIGS. 3A-B are a first flowchart showing an example of each program installation process. FIGS. 4A-B is a second flowchart showing an example of each program installation process.

In FIGS. 3A-B, a process 500 is an operation process of each of the cameras 102a and 102b. A process 520 is an operation process of the TV 101. A process 550 is an operation process of the server 103. A main controller of each operation process is the CPU 201 in each apparatus unless otherwise indicated.

In step S501, each (hereinafter referred to as the “camera 102”) of the cameras 102a and 102b is connected to the TV 101. Regarding a connection form, the camera 102 may be connected to the TV 101 via the network 105 as in the case of connecting the camera 102a in FIG. 1, or may directly be connected as in the case of connecting the camera 102b in FIG. 1. In step S521, the TV 101 detects connection to the camera 102.

In step S502, the camera 102 transmits apparatus information of the camera 102 to the TV 101 when connection is established. The apparatus information includes model information of the camera 102, identification (ID) identifying the camera 102, and an operation program version number. In step S522, the TV 101 receives the apparatus information.

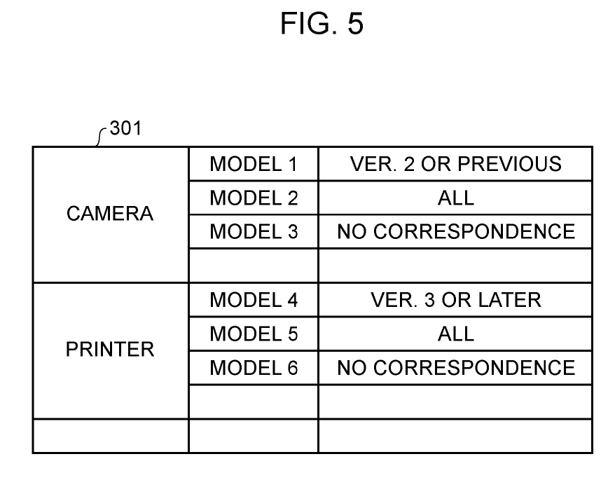

In step S523, on the basis of the received apparatus information, the TV 101 determines whether a presently executed program supports the connected camera 102. The TV 101 determines on the basis of a supported apparatus list stored in the RAM 203 (or the hard disk 211 or the flash ROM 209). An example of the supported apparatus list is denoted by reference numeral 301 in FIG. 5. FIG. 5 is an illustration of the example of the supported apparatus list.

The supported apparatus list 301 indicates which of the cameras 102a and 102b, or which of the printers 104a and 104b, a program of a version presently installed in the TV 101 supports. FIG. 5 shows that the program of the version presently installed in the TV 101 supports Models 1 and 2 of the camera 102, and does not support Model 3 of the camera 102. In addition, FIG. 5 shows that the program of the version presently installed in the TV 101 supports a program in version 2 and previous programs of Model 1 of the camera 102, and supports programs in all versions of Model 2 of the camera 102.

If, in future, Model 2 of the camera 102 is functionally enhanced, it may not be said that the program of the version presently installed in the TV 101 supports all the versions. However, if there is no version upgrade opportunity since production has already stopped, it may be said that the program of the version presently installed in the TV 101 supports all the versions. In addition, it is also possible that programs in version XXX or later be specified. In this case, there is no version upgrade opportunity for the model, and programs in version XXX and older are not supported since specifications are old. This similarly applies to the case of the printers 104a and 104b.

The program version number mentioned here represents a version number of all operation programs for the apparatus. Therefore, support of the connected camera 102 by the TV 101 indicates that the operation program of the TV 101 supports all functions requested from the TV 101 by the camera 102.

Now referring back to FIG. 3A, if in step S523, the TV 101 has determined that the program of the TV 101 does not support the camera 102, in step S524, the TV 101 checks whether a support program can be installed from the CD-ROM drive 213.

In the TV 101, the CD-ROM drive 213 has a program-stored CD-ROM medium. When the supported apparatus list 301 indicates support of the connected camera 102, the TV 101 determines that the support program can be installed. In this case, for each version number of the program, the supported apparatus list 301 exists. Such supported apparatus lists 301 may be stored in the RAM 203 (or the hard disk 211 or the flash ROM 209), or may be stored in the CD-ROM medium with the program.

If, in step S524, it is determined that the program can be installed, in step S527, the TV 101 acquires a program supporting the camera 102 from the CD-ROM medium. The camera 102 selectively acquires not only a program that simply supports the connected camera 102, but also the latest program. This operation is effective when considering bug correction and a case in which a camera 102 of a different model is connected.

In the above description, the support program is stored in the CD-ROM medium, and the CD-ROM medium acquires the support program from the CD-ROM medium. This does not limit the storage location to the CD-ROM medium. A common storage medium may be used as a medium as the storage location.

Now referring to FIG. 3B, in step S530, after acquiring the program, the TV 101 installs the acquired program into the TV 101. The TV 101 replaces the supported apparatus list 301 for the TV 101 in the RAM 203 by a supported apparatus list 301 corresponding to the version number of the installed program.

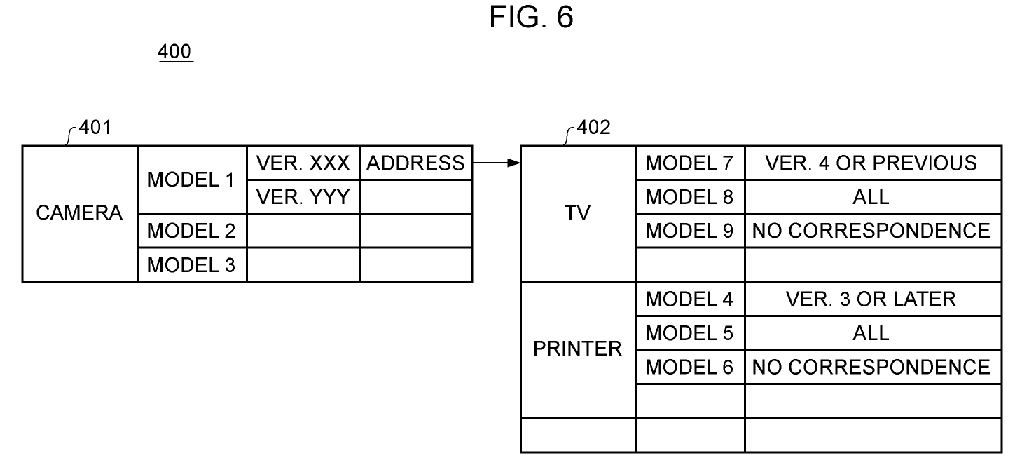

In step S531, the TV 101 determines whether the RAM 203 (or the hard disk 211 or the flash ROM 209) stores the supported apparatus list 301 for the camera 102. FIG. 6 is an illustration of an example of a supported apparatus list 400 for the camera 102.

The supported apparatus list 400, for the camera 102, shown in FIG. 6 differs from the supported apparatus list 301 of the TV 101, and includes a supported apparatus list 402 for each model and version of the camera 402, and an address table 401. This configuration is intended to support models and versions of the camera 102. In the address table 401, models and versions of the camera 102 are associated with addresses to the supported apparatus list 402.

If, in step S531, it is determined that the TV 101 has the supported apparatus list 400, in step S532, on the basis of the apparatus information of the camera 102 and the supported apparatus list 400, the TV 101 determines whether to install a program into the camera 102.

The TV 101 refers to the supported apparatus list 402, which corresponds to model information and version number (information) included in the apparatus information of the camera 102. The TV 101 determines whether the TV 101 satisfies model-information-and-version number information in a corresponding TV cell in the supported apparatus list 402. If the conditions are not satisfied by the TV 101, the TV 101 determines that the operation program (the program installed in the TV 101) is later than the program in the version, that is, the operation program has been updated. After that, in order for the camera 102 to support updated functions, the TV 101 determines whether to install the program for the camera 102 into the camera 102.

Here, the version number of the installed program is used as the version number of the program of the TV 101 used in the decision in step S532 if, in step S530, the program is installed.

If, in step S532, the TV 101 has determined to install a program into the camera 102, in step S533, the TV 101 checks whether the program for the camera 102 can be installed from the CD-ROM drive 213. Step S533 is similar in processing to step S524. Specifically, when the CD-ROM drive 213 has a CD-ROM medium containing the program for the TV 101, and a supported apparatus list of the program in the version indicates support of the TV 101, the TV 101 determines that the program for the camera 102 can be installed.

Now referring to FIG. 4A, if the TV 101 has determined that the program for the camera 102 can be installed, the TV 101 acquires the program for the camera 102 (step S604 in FIG. 4A). In step S605, the TV 101 reports (transmits) a “PROGRAM INSTALLATION” message to the camera 102.

When the camera 102 receives the “PROGRAM INSTALLATION” message (Y in step S601), the camera 102 proceeds to step S602.

In step S606, the TV 101 transmits the program acquired in step S604 to the camera 102. When transmitting the acquired program to the camera 102, the TV 101 also transmits a version number of the program to be transmitted. This information is used when apparatus information is transmitted in step S502 in the next connection.

In step S602, the camera 102 receives the program and version number transmitted from the TV 101. The camera 102 stores the program version number simultaneously transmitted with the program in a memory or the like. In step S603, the camera 102 installs the program thereinto. After step S603, the camera 102 finishes the process.

After that, when installation of the program is completed, each of the TV 101 and the camera 102 activates the installed program (the activation is not shown). This makes it possible to execute some service or function provided by the installed program.

Now referring back to FIG. 3A, if in step S523, the TV 101 has determined that the program of the TV 101 supports the camera 102, the TV 101 proceeds to step S531 without installing a new program.

If, in step S532 (see FIG. 3B), the TV 101 has determined not to install the program also into the camera 102, in step S534, the TV 101 reports a “NO PROGRAM INSTALLATION” message to the camera 102.

Referring to FIG. 4A, when the camera 102 receives the “NO PROGRAM INSTALLATION” message (NO in step S601), the camera 102 finishes the process without installing the program.

Next, processes in which the TV 101, etc., acquire programs from the server 103 before acquiring the programs thereinto are described below with reference to the flowcharts shown in FIGS. 3A-B and 4A-B.

If, in step S524 (see FIG. 3A), the TV 101 has determined that the program for the TV 101 cannot be installed from the CD-ROM drive 213, in step S526, the TV 101 transmits the apparatus information of the TV 101 to the server 103. The apparatus information includes model information of the TV 101, ID identifying the TV 101, and a version number of an operation program version number. In addition, the apparatus information also includes model information of the camera 102 and an operation program version number of the camera 102. In step S551, the server 103 receives the apparatus information.

In step S552, on the basis of the received apparatus information, the TV 101 determines whether it stores a program to be installed into the TV 101. The decision in step S552 is similar to decision in step S532 of whether the TV 101 stores the program to be installed into the camera 102. In other words, in the server 103, its memory or the like stores a supported apparatus list (not shown) concerning the TV 101. The supported apparatus list is similar in configuration to the supported apparatus list 400 concerning the camera 102. The server 103 determines on the basis of the supported apparatus list, etc.

If, in step S552, the server 103 has determined that the TV 101 stores the program to be installed, in step S553 (see FIG. 3B), the server 103 reports the “PROGRAM INSTALLATION” message to the TV 101.

When the TV 101 receives the “PROGRAM INSTALLATION” message (Y in step S528), the TV 101 proceeds to step S529.

In step S554, the server 103 transmits the program to the TV 101. When transmitting the program to the TV 101, the server 103 also transmits a version number of the program to be transmitted and the supported apparatus list 301 corresponding to the version number.

In step S529, the TV 101 receives the program, program version number, and supported apparatus list 301 transmitted from the server 103. In step S530, the TV 101 receives the received program thereinto. The TV 101 sets the received version number as the present version number, and uses the received supported apparatus list 301 to update the present supported apparatus list 301.

If, in step S552, the server 103 has determined that the TV 101 does not store the program to be installed, in step S555, the server 103 reports the “NO PROGRAM INSTALLATION” message to the TV 101.

When the TV 101 receives the “NO PROGRAM INSTALLATION” message (N in step S528), the TV 101 proceeds to step S531 without installing the program thereinto.

If, in step S531, the TV 101 has determined that the RAM 203 does not store any supported apparatus list for the camera 102, the TV 101 proceeds to step S607. In addition, if, in step S533, the TV 101 has determined that the program for the camera 102 cannot be installed from the CD-ROM drive 213, the TV 101 proceeds to step S607 (see FIG. 4A).

In step S607, the TV 101 transmits the apparatus information of the camera 102 and the apparatus information of the server 103 to the server 103. In step S613 (see FIG. 4B), the server 103 receives the apparatus information of the camera 102 from the TV 101.

In step S614, on the basis of the received apparatus information of the camera 102, the received apparatus information of the server 103, and the supported apparatus list 400, the server 103 determines whether a program that is to be installed into the camera 102 is stored. The server 103 stores the supported apparatus list 400 in a memory or the like.

If, in step S614, the server 103 has determined that the program to be installed is stored, in step S615, the server 103 reports the “PROGRAM INSTALLATION” message to the TV 101. When the TV 101 receives the “PROGRAM INSTALLATION” message (Y in step S608), the TV 101 proceeds to step S609.

In step S616, the server 103 transmits the program for the camera 102 to the TV 101. When transmitting the program for the camera 102 to the TV 101, the server 103 also transmits a version number of the program to be transmitted and a supported apparatus list 400 corresponding to the version number.

In step S609, the TV 101 receives the program, version number, and supported apparatus list 400 transmitted from the server 103. The received supported apparatus list 400 is used in step S531 (see FIG. 3B) when the TV 101 is connected to the TV 101 the next time. If, in the decision in step S531, the TV 101 only needs to always proceed to step S607, in step S615, the server 103 does not need to transmit the supported apparatus list 400.

In step S611, the TV 101 reports the “PROGRAM INSTALLATION” message to the camera 102. In step S612, the TV 101 transmits, to the camera 102, the program for the camera 102 received from the server 103. When transmitting the program for the camera 102, the camera 102 also transmits a version number of the program to be transmitted.

If, in step S614, the server 103 has determined that the program to be installed into the camera 102 is not stored, in step S617, the server 103 reports the “NO PROGRAM INSTALLATION” message to the TV 101. When the “NO PROGRAM INSTALLATION” message from the server 103, in step S610, the TV 101 proceeds to step S610 and reports the “NO PROGRAM INSTALLATION” message to the camera 102.

In the description with reference to FIGS. 3 and 4, if the TV 101 stores the program for the camera 102, the TV 101 directly transmits the program for the camera 102 to the camera 102. In addition, if the TV 101 does not store the program for the camera 102, the TV 101 queries the server 103 about whether the program for the camera 102 is stored. If the server 103 stores the program for the camera 102, the program for the camera 102 is transmitted from the server 103. However, it is not always required that the TV 101, the camera 102, and the server 103 be configured as described above.

Only one of a process in which the TV 101 supplies a program to the camera 102 and a process in which the server 103 supplies a program to the camera 102 through the TV 101 may be provided. In this case, unnecessary decisions and steps are omitted in the flowcharts shown in FIGS. 3 and 4.

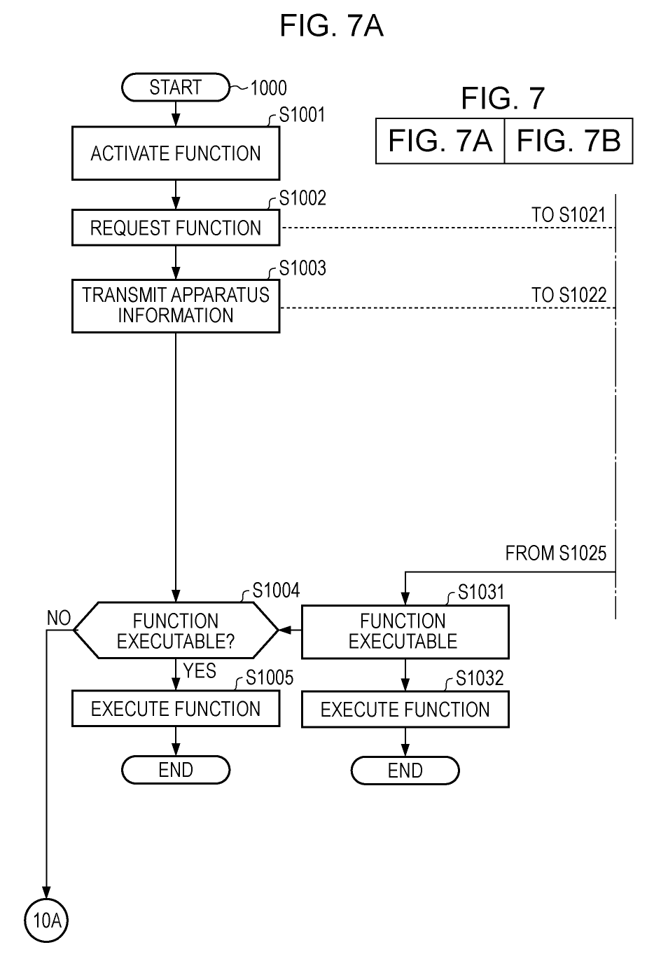

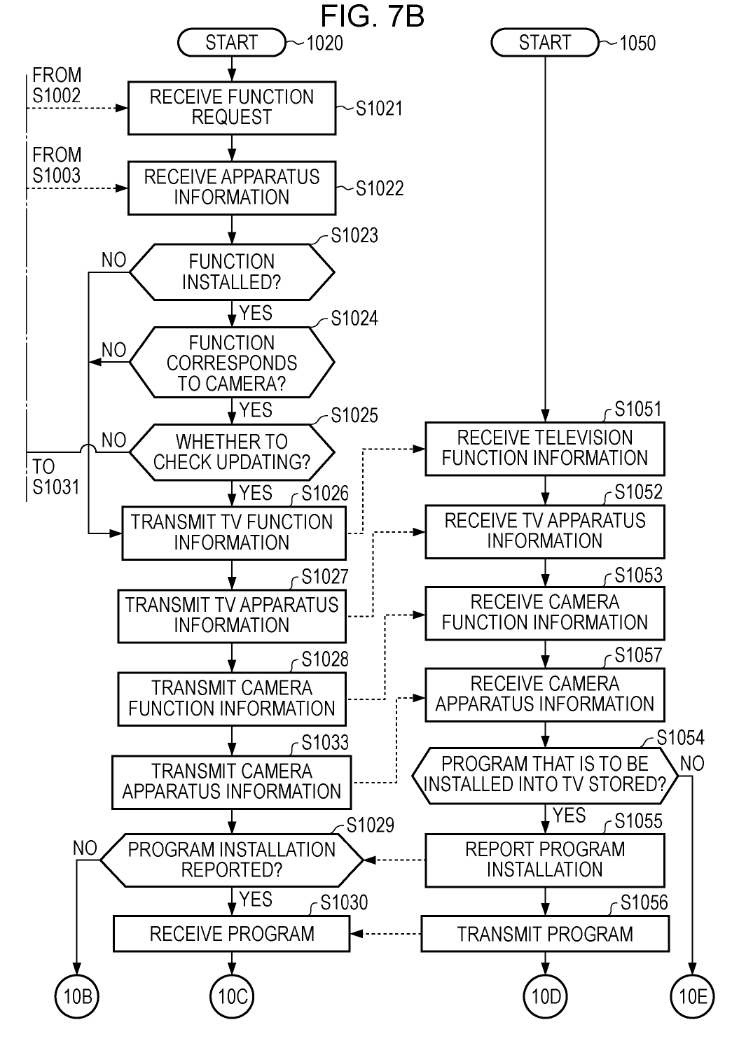

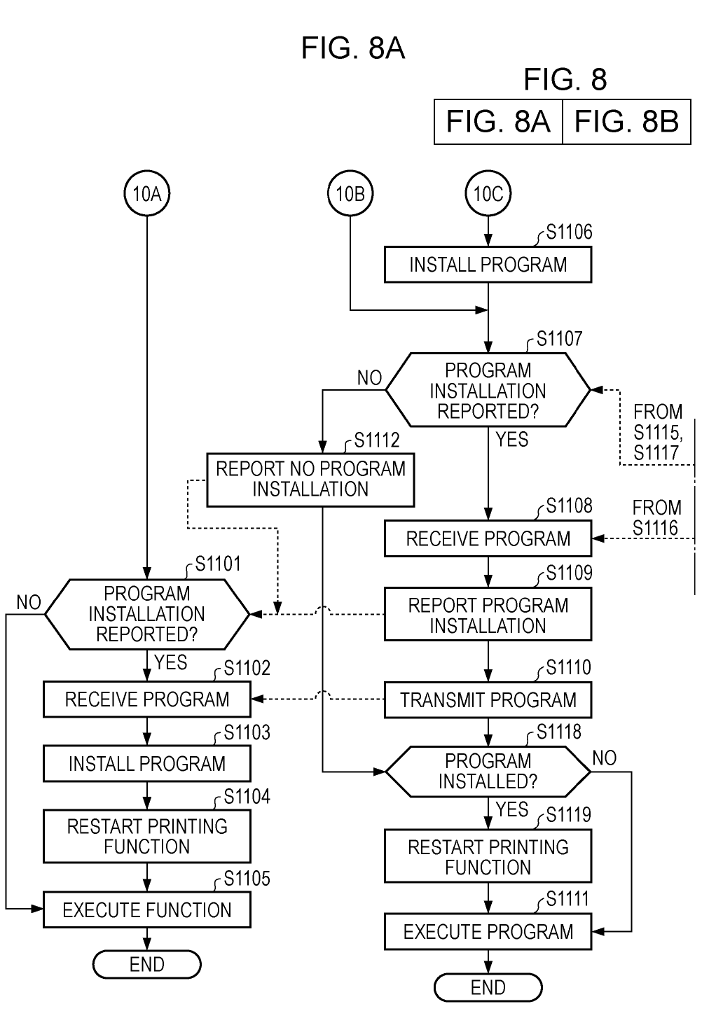

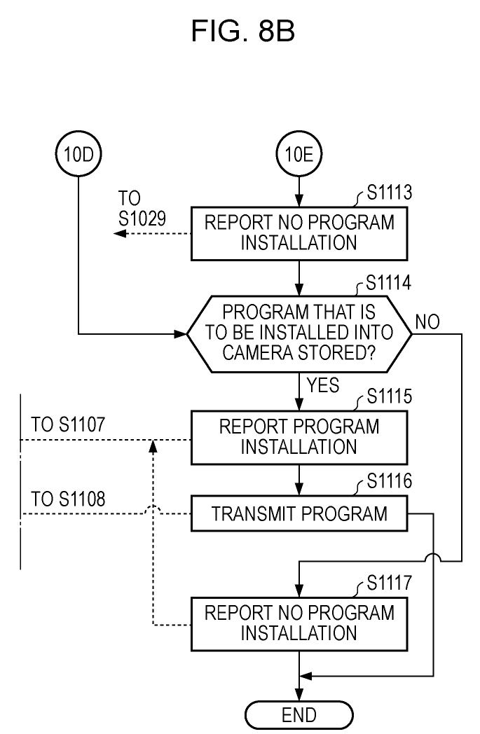

Next, an exemplary installation process in which, if, at the start of a predetermined function, the function is not supported, a program for providing the function is installed is described below with reference to the flowcharts shown in FIGS. 7A-B and 8A-B. FIGS. 7A-B are a first flowchart showing an example of the installation process for providing the function. FIGS. 8A-B are a second flowchart showing an example of the installation process for providing the function.

Now referring to FIGS. 7A-B, a process 1000 is an operation process of the camera 102. A process 1020 is an operation process of the TV 101. In addition, a process 1050 is an operation process of the server 103. A main controller of each operation process is the CPU 201 of each apparatus unless otherwise indicated.

In step S1001, the camera 102 activates a predetermined function. At this time, the camera 102 and the TV 101 have already been connected to each other, and the TV 101 and each of the printers 104a and 104b have already been connected to each other. The predetermined function activated by the camera 102 in step S1001 is a printing function for transmitting an image in the camera 102 to the printer 104 through the TV 101 and printing the image. Although, in the above description, the apparatuses have already been connected, each apparatus may be connected after the function is activated.

In step S1002, the function activation causes the camera 102 to transmit, to the TV 101, a message (function requesting message) requesting execution of the function. In step S1021 (see FIG. 7B), the TV 101 receives the function requesting message from the camera 102. Although, in step S1021, the function requesting message is transmitted, there are a large number of other methods for reporting the function request. In addition, as a protocol for use, a unique protocol may be used either in hardware or in software. Alternatively, a standard protocol may be used. In the case of using any protocol, it is only required that a function requested in the protocol be identified.

For example, data in a portion of a unique binary data format may be set as a command value identifying a requested function. In addition, when TCP/IP (Transmission Control Protocol/Internet Protocol) is used in a “client-server protocol”, an application at a communication party can be determined with a port number. In this case, determination of the application can be regarded as selection of a function. In addition, when activation of a CGI (Common Gateway Interface) or Java servlet is requested by designating a URL (uniform resource locator), the URL is a key for identifying a function.

In this embodiment, a function is defined as an “activity” provided such that two apparatuses connected to each other execute some programs. In other words, although the above embodiment includes the term “function request”, provision of a function is not provided by program execution of only the TV 101. There is also involvement of the camera 102, such as selection of a function, request of activation, and parameter specification. When a function is executed, both apparatuses have programs (hereinafter referred to as “function programs”) concerning the function, and, on the basis of the programs, CPUs or the like in both apparatuses operate to realize the function.

In step S1003, the camera 102 transmits its apparatus information. The apparatus information includes model information of the camera 102, an ID identifying the camera 102, and a version number of a function program of the camera 102 concerning the requested function. In step S1022 (see FIG. 7B), the TV 101 receives the apparatus information.

Although the version number of the function program is included in the apparatus information, if the function request message, or the like, in step S1002 can include the version number, the version number may be included that way. In this case, the apparatus information does not need to include the version number.

In step S1023, the TV 101 determines whether the TV 101 is ready to provide the requested function, that is, whether the function program has already been installed.

If the TV 101 is ready to provide the requested function, the TV 101 attempts to install the function program, as described in the following. However, at this time, the TV 101 does not reject the function request from the camera 102. As described above, for example, if a specification of the function is a command value in a binary data format, until the TV 101 responds with a rejection response to the command, the TV 101 is regarded as rejecting the request. Thus, the TV 101 continuously installs the function program.

When a specification of the function is a port number specification, if the TV 101 does not detect any application assigned to the port number, normally, a transport protocol layer of the TV 101 reports service rejection to the camera 102. However, in this manner, the function cannot be provided after the function program is installed. To solve this problem, in this embodiment, the TV 101 activates beforehand an application (dummy application) for a port number expected to be specified. The transport protocol layer can temporarily receive the function request from the camera 102. The dummy application identifies the requested function and confirms the existence of the function program.

In addition, this similarly applies to a case in which a function specification is a URL. If a particular function program is not assigned to a specified URL, the TV 101 in this embodiment activates a dummy CGI or Java servlet. The dummy CGI or Java servlet identifies the requested function and confirms the existence of the function program.

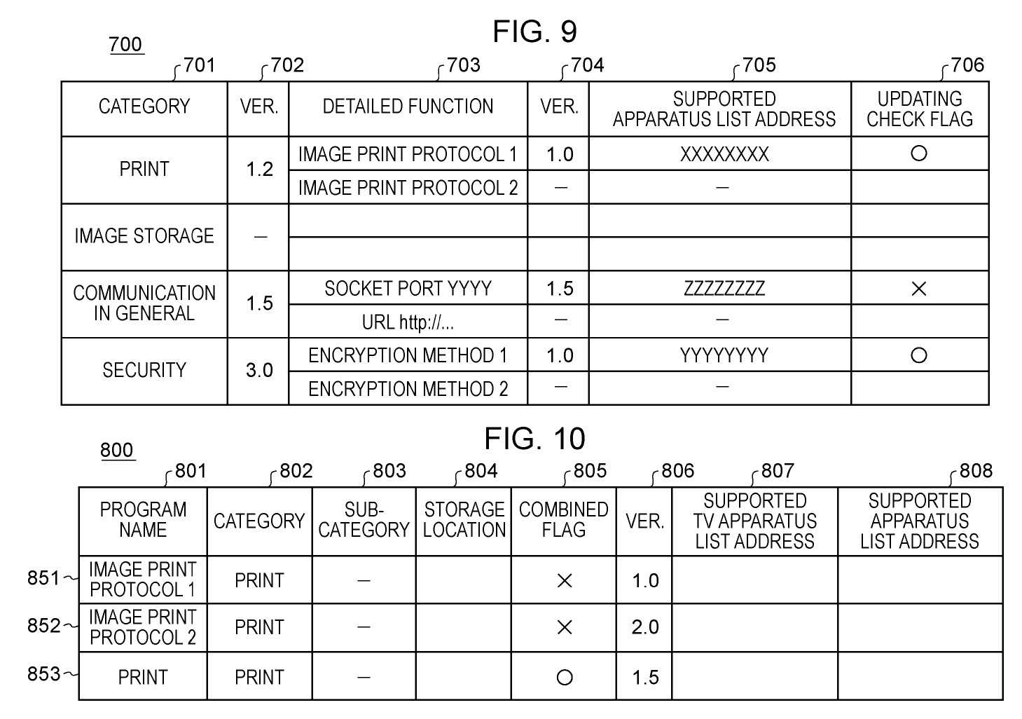

When identifying the function, the TV 101 or the like performs identifying based on a category or detailed function. Accordingly, the RAM 203 in the TV 101 stores the function table 700 shown in FIG. 9. FIG. 9 is an illustration of an example of the function table 700.

The function table 700 stores types of function programs presently installed in the TV 101 and version numbers of the function programs. A function and a function program are identified by a category 701 and a detailed function 703. The function and function program can be specified by either item. Which item the function and function program are specified by depends on a protocol used when the function is specified. For example, when a “print function” is specified, a function program for “PRINT” in the category 701 is specified. When a “print function using image print protocol 1” is specified, a function program for “IMAGE PRINT PROTOCOL 1” is specified. Function programs indicated in the detailed function 703 correspond to actual programs, respectively. Unlike that, each function program indicated in the category 701 represents a set of detailed functions belonging to the category 701.

The function program in the category 701 corresponds to the version number 702. Each function program in the detailed function 703 corresponds to a version number 704. When a field of the version number 702 or 704 has the symbol “-”, it is indicated that the function program is not installed. The function table 700 is an example of function classification. Accordingly, functions may be classified by other classification methods, etc., and data may be stored. For example, in the function table 700, the category 701 may include a subcategory having more fine classification.

Now referring back to FIG. 7B, if in step S1023, the TV 101 has determined that the identified function program is installed, in step S1024, the TV 101 determines whether the function program supports the camera 102.

For this decision, the function table 700 includes a supported apparatus list address column 705. The supported apparatus list address column 705 contains addresses directed to supported apparatus lists 301 corresponding to function programs. In this embodiment, the supported apparatus list 301 is a list of supported apparatuses that are supported by all the programs installed in the TV 101. However, the supported apparatus list 301 in this embodiment corresponds to each function program, and the number of supported apparatus lists 301 is plural.

On the basis of the contents of the supported apparatus list 301 represented by the supported apparatus list address 705 corresponding to the function program, and the received apparatus information of the camera 102, the TV 101 determines whether the function program supports the camera 102.

If, in step S1024, the TV 101 has determined that the function program supports the camera 102, in step S1025, the TV 101 determines whether to check updating of the function program.

For this decision, the function table 700 includes an updating check flag 706. When a field of the updating check flag 706 has a circle mark, the TV 101 determines to check updating of the function program. Alternatively, when a field of the updating check flag 706 has an X mark, the TV 101 determines not to check updating of the function program. The updating check flag 706 can be arbitrarily set for each function program, for example, by a user or the like.

If, in step S1025, the TV 101 has determined not to check updating of the function program, in step S1031 (see FIG. 7A), the TV 101 responds to the camera 102 with a “Function Executable” message indicating that the requested function is executable. In step S1032, the TV 101 actually provides the function by executing the function program for the requested function. After that, the process of the TV 101 finishes.

In step S1004, the camera 102 determines whether the message received from the TV 101 is a “Function Executable” message. If the camera 102 has determined that it has received the “Function Executable” message, in step S1005, the camera 102 continuously executes the function program corresponding to the activated function (the “print function” here). After that, the process of the camera 102 finishes.

If, in step S1023, the TV 101 has determined that the identified function program is not installed, the TV 101 proceeds to step S1026. And, if in step S1024, the TV 101 has determined that the function program does not support the camera 102, the TV 101 proceeds to step S1026. If, in step S1025, the TV 101 has determined to check updating of the function program, the TV 101 proceeds to step S1026. In other words, the TV 101 proceeds to querying of the server 103 about whether the server 103 stores a program to be installed.

As described with reference to the flowchart in FIG. 3, the TV 101 may check whether a program can be installed from the CD-ROM drive 213. In this embodiment, this processing is not described for brevity of description.

In step S1026, the TV 101 transmits, to the server 103, information (TV function information) concerning the function (the print function here) of the TV 101 which is requested by the camera 102. In step S1051, the server 103 receives the TV function information. The TV function information includes an ID or name identifying a function or function program, or a version number of a function program of the TV 101. The TV 101 obtains these pieces of information from the version number 702 or 704 in the function table 700. When the function program is not installed, the TV 101 transmits, to the server 103, a predetermined version number indicating that the function program is not installed.

In step S1027, the TV 101 transmits its apparatus information (hereinafter referred to as “TV apparatus information”) to the server 103. In step S1052, the server 103 receives the TV apparatus information. The TV apparatus information includes model information of the TV 101 and an ID identifying the TV 101.

In step S1028, the TV 101 transmits, to the server 103, function information (hereinafter referred to as “camera function information”) of the camera 102. In step S1053, the server 103 receives the camera function information. The camera function information includes an ID or name identifying a function or function program, and a version number of the function program. The TV 101 obtains the version number of the function program from, for example, the apparatus information received in step S1022. The TV 101 may use, as an ID or name identifying a function, for example, those included in the TV function information transmitted in step S1026.

If an ID or name of a function of the camera 102 is used in common to the function table 700 of each of the TV 101 and the camera 102, and a function program table 800 (described later) or the like, the TV 101 can use those included in the TV function information in step S1026. In such a case, it is not necessary to transmit the ID or name of the function from the camera 102 to the TV 101. If IDs or names of different functions must be used between the TV 101 and the camera 102, information of the ID or name of one function is transmitted from the camera 102 to the TV 101, and, in step S1028, the information is used and transmitted.

In step S1033, the TV 101 transmits apparatus information (hereinafter referred to as “camera apparatus information”) of the camera 102 to the server 103. In step S1057, the server 103 receives the camera apparatus information. The camera apparatus information includes model information of the camera 102 and an ID identifying the camera 102.

In step S1054, on the basis of the TV apparatus information, the TV function information, etc., the server 103 determines whether a program to be installed into the TV 101 is stored. For this decision, the server 103 stores the function program table 800 shown in FIG. 10 in the RAM 203. FIG. 10 is an illustration of an example of the function program table 800.

The function program table 800 is a table concerning function programs for the TV 101, and includes the following information for each function program. Specifically, the function program table 800 contains information of a program name 801 (a function program ID may be used) representing names of function programs, a category 802, a subcategory 803, and a storage location 804 representing portions in the server 103 where the function programs are stored. The function program table 800 also contains information of a combined flag 805 indicating a set of function programs, and a version number 806. The function program table 800 also contains information of a supported TV apparatus list address 807 representing addresses directed to a supported TV apparatus list indicating whether each function program supports the TV 101. In addition, the function program 800 includes information of the supported apparatus list address 808 representing an address directed to which version of a support function program of the connected apparatus a function program corresponds. The format of the supported apparatus list is similar to the supported apparatus list 301.

A supported TV apparatus list (not shown) includes a list of models of the TV 101 in which each function program can operate. This list may include version numbers of all the programs of the TV 101 in which the function program can operate in the environment.

Specification of the function program for the function program table 800 may be performed either at a detailed function level or at a category level. This is because “IMAGE PRINT PROTOCOL 1” 851 or “IMAGE PRINT PROTOCOL 2” 852, and “PRINT” 853 are contained at the same level in the function program table 800.

Now referring back to FIG. 7B, in step S1054, in a case in which, although the function program is not installed in the TV 101, the function program is stored in the server 103, the server 103 determines that the program to be installed is stored. In addition, in step S1054, in a case in which, although the function program is installed in the TV 101, a program in a later version is stored in the server 103, the server 103 determines that the program to be installed is stored. In both cases, the TV apparatus information must satisfy conditions represented by the supported TV apparatus list indicated by the supported TV apparatus list address 807, and the camera apparatus information and the camera function information must satisfy conditions represented by the supported apparatus list indicated by the supported apparatus list address 808.

If, in step S1054, the server 103 has determined that the program to be installed is stored, in step S1055, the server 103 reports the “PROGRAM INSTALLATION” message to the TV 101.

At step S1029, the TV 101 determines whether the program installation has been reported. If yes, that is to say, when the TV 101 receives the “PROGRAM INSTALLATION” message, the TV 101 proceeds to step S1030.

In step S1056, the server 103 acquires the function program from a location represented by the storage location 804, and transmits the acquired function program to the TV 101.

When a field of the combined flag 805 has a circle mark, the function program includes a plurality of programs. In this case, the storage location 804 represents not a storage location but a combined program table. For example, a combined program table for a print program in version 1.5 includes for example, a program name, subcategory, storage location, version, supported TV apparatus list address, and supported apparatus list of each of a plurality of programs included in the print program in version 1.5.

The server 103 can know a storage location of each function program from the combined program table, and can transmit a plurality of programs to the TV 101.

When transmitting the function program to the TV 101, the server 103 also transmits the version number of the function program to be transmitted. When transmitting the function program to the TV 101, the server 103 may transmit a supported apparatus list 301 corresponding to the version number of the function program to be transmitted, if necessary.

In step S1030, the TV 101 receives the function program and version number transmitted from the server 103. The TV 101 also receives the supported apparatus list 301 corresponding to the function program transmitted from the server 103, if necessary. In step S1106 (see FIG. 8A), the TV 101 installs the received function program thereinto.

If, in step S1054, the server 103 has determined that the program to be installed into the TV 101 is not stored, in step S1113 (see FIG. 8B), the server 103 reports the “NO PROGRAM INSTALLATION” message.

Further, when receiving the “NO PROGRAM INSTALLATION” message in S1029 (see FIG. 7B), the TV 101 proceeds to step S1107.

After transmitting the function program in step S1056, in step S1114 (see FIG. 8B), the server 103 determines whether the program to be installed into the camera 102 for providing the function activated in step S1000 is stored in the server 103.

The function program table 800 is a table of function programs for the TV 101. The RAM 203 of the server 103 stores a function program table for the camera 102 which is similar to the above table. Similarly to step S1054, the server 103 uses this table to determine whether the program to be installed into the camera 102 for providing the function activated in step S1000 is stored in the server 103.

More specifically, in a case in which, although the function program is not installed in the camera 102, the server 103 stores the function program for the camera 102, in step S1114, the server 103 determines that the program to be installed into the camera 102 is stored in the server 103. Alternatively, in a case in which the server 103 stores a function program in a version later than the version of the function program installed in the camera 102, in step S1114, the server 103 determines that the program to be installed into the camera 102 for providing the function activated in step S1000 is stored in the server 103.

In both cases, the apparatus information of the camera 102 must satisfy conditions represented by a supported camera apparatus list indicated by the supported camera apparatus list address, and the apparatus information of the camera 102 must satisfy conditions represented by the supported apparatus list indicated by the supported apparatus list address 808. Here, the supported camera apparatus list, which is not shown, corresponds to the supported TV apparatus list address 807.

The supported camera apparatus list is a list of apparatuses corresponding to model information of the camera 102 and a version number of each function program. The supported camera apparatus list describes conditions concerning model information of each apparatus (the TV 101 in this case) that can operate cooperatively with the camera 102, and a version number of each function program. Regarding the version number of the function program (of the TV 101) used in decision in step S1114, if the function program is installed in step S1106, the version number of the function program is used.

When the camera 102 activates a function, it is possible that a function program for using the function be not installed in the camera 102. It is assumed that, in steps S1056, S1030, etc., the function program transmitted from the server 103 be installed into the TV 101. It is also assumed that a function program for the camera 102 in order to use the function program (or the function) be stored in the server 103 or the like. At this time, the function program has not been installed in the camera 102 yet. Thus, this function program needs to be installed into the camera 102.

When the function program to be installed into the camera 102 is stored in the server 103, in step S1115, the server 103 reports the “PROGRAM INSTALLATION” message to the TV 101. When the function program to be installed is not stored, in step S1117, the server 103 reports the “NO PROGRAM INSTALLATION” message to the TV 101.

In step S1107, the TV 101 determines whether the “PROGRAM INSTALLATION” message has been reported. If the “NO PROGRAM INSTALLATION” has been reported, the TV 101 proceeds to step S1112, and reports the “NO PROGRAM INSTALLATION” message to the camera 102. Otherwise, the TV 101 proceeds to step S1108 (see FIG. 8A).

Further, after step S1115, in step S1116, the server 103 transmits the function program for the camera 102 to the TV 101. When transmitting the function program to the TV 101, the server 103 also transmits the version number of the function program. When transmitting the function program to the TV 101, the server 103 may transmit a supported apparatus list 301 corresponding to the version number of the function program to be transmitted, if necessary.

In step S1108, the TV 101 receives the function program and version number transmitted from the server 103. In step S1109, the TV 101 reports the “PROGRAM INSTALLATION” message to the camera 102.

Now referring back to FIG. 7A, if in S1004 the function is not executable, then the process proceeds to S1101 (see FIG. 8A). In S1101, it is determined whether the “PROGRAM INSTALLATION” has been reported.

If the “PROGRAM INSTALLATION” message has been reported, the camera 102 proceeds to step S1102. Otherwise, if the “PROGRAM INSTALLATION” message is not reported in step S1101, then the function is executed in step S1105 and then the process ends.

After step S1109, in step S1110, the TV 101 transmits the function program to the camera 102. In step S1102, the camera 102 receives the function program.

In step S1118, the TV 101 determines whether it has installed the function program there into the TV 101 in step S1106.

If the TV 101 has determined that it has installed the function program there into the TV 101, in step S1119, the TV 101 reactivates the installed function program in order to reactivate the installed function (the print function, for example, here). If the TV 101 has determined that it has not installed the function program thereinto, the TV 101 skips over step S1119. Finally, in step S1111, the process of the TV 101 finishes by executing the program.

In step S1103, the camera 102 installs the received function program. Next, in step S1104, the camera 102 reactivates the function program in order to reactivate the installed function (the print function, for example, here. Finally, in step s1105, the camera 102 executes the function. The process of the camera 102 finishes.

If, in step S1101, the “PROGRAM INSTALLATION” message is not reported, the camera 102 proceeds to step S1105 without installing the function program.

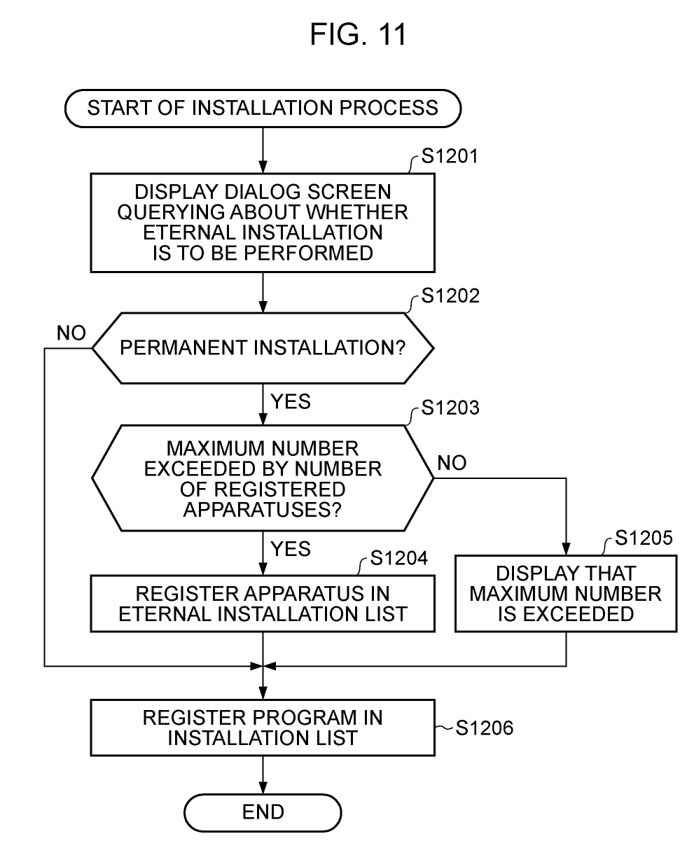

Next, exemplary installation and uninstallation are described below with reference to the flowchart shown in FIG. 11.

FIG. 11 is a flowchart showing an example of an installation process for installing a program. The process shown in FIG. 11 is applicable to either the TV 101 (steps S530, S1106) or the camera 102 (steps S603, S1103). For brevity of description, the TV 101 is used in the following description.

In step S1201, when installing a program, the TV 101 displays, on the display 205, a dialog screen for querying about whether the installation is permanent.

The user uses the operation buttons 208 to respond to the dialog. On the basis of the response to the dialog, the TV 101 determines whether the installation is permanent. If the TV 101 has determined that the installation is permanent (YES in step S1202), the TV 101 proceeds to step S1203. If the TV 101 has determined that the installation is not permanent (NO in step S1202), the TV 101 proceeds to step S1206. In step S1203, the TV 101 determines whether the number of registered apparatuses on a permanent installation list of programs exceeds a predetermined maximum number of registered apparatuses.

If the TV 101 has determined that the number of registered apparatuses does not exceed the maximum number (N in step S1203), in step S1204, the TV 101 registers, in the permanent installation list, an apparatus to which the TV 101 is connected. If the TV 101 has determined the number of registered apparatuses exceeds the maximum number (YES in step S1203), in step S1205, the TV 101 displays the decision.

Finally, in step S1206, the TV 101 registers a program in an installation list of installed programs. The process of the TV 101 in FIG. 11 finishes. Further, the TV 101 also executes a step (or processing) for installing a program, but this step is not shown in FIG. 11.

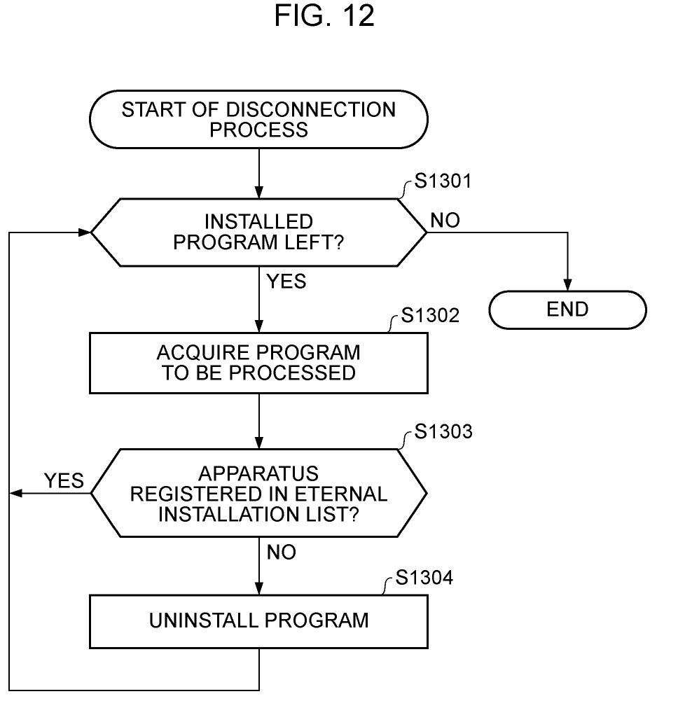

Next, a disconnection process is described with reference to the flowchart shown in FIG. 12. FIG. 12 is a flowchart showing an example of the disconnection process. The flowchart shown in FIG. 12 is applicable to either the TV 101 or the camera 102. For brevity of description, the TV 101 is used in the following description.

In step S1301, when connection between two apparatuses is disconnected, by referring to the installation list, the TV 101 determines whether, among the installed programs, a program in which the following cancellation has not been performed yet is left.

If the TV 101 has determined that the program in which the following cancellation has not been performed yet is not left (NO in step S1301), the process in FIG. 12 finishes. If the TV 101 has determined that program in which the following cancellation has not been performed yet is left (YES in step S1301), the TV 101 proceeds to step S1302.

In step S1302, the TV 101 acquires a program to be processed from the installation list. In step S1303, the TV 101 determines whether, regarding the acquired program, an other party apparatus to be disconnected is registered in the permanent installation list.

If the TV 101 has determined that the other party apparatus is not registered in the permanent installation list (NO in step S1303), the TV 101 proceeds to step S1304. In step S1304, the TV 101 uninstalls a program to be processed. If the TV 101 has determined that the other party apparatus is registered (YES in step S1303), the TV 101 proceeds to step S1301 for the next program.

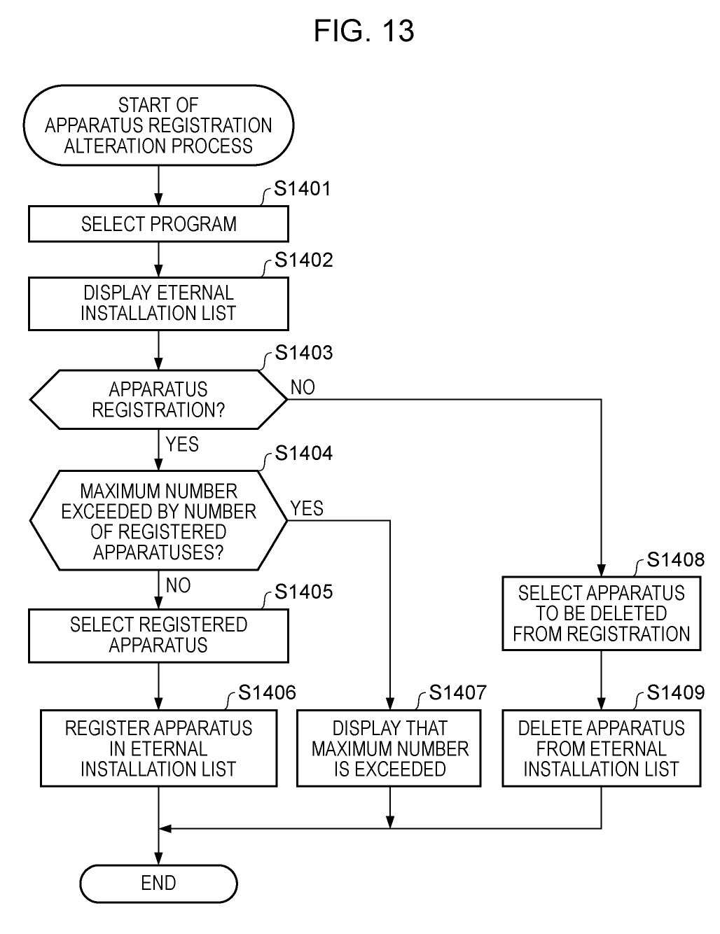

Next, an example apparatus registration alteration process is described below with reference to the flowchart shown in FIG. 13. FIG. 13 is a flowchart showing an example of the apparatus registration alteration process. The flowchart in FIG. 13 is applicable to either the TV 101 or the camera 102. For brevity of description, the TV 101 is used in the following description.

In step S1401, a program whose registration is to be altered is selected by the user with a predetermined user interface such as a dialog, whereby information of the program selected by the user is acquired.

In step S1402, on the basis of the information, the TV 101 displays the contents of a permanent installation list concerning the user-selected program.

Next, selection of a processing method by the user causes the TV 101 to acquire information identifying the user-selected processing method. In step S1403, on the basis of the information, the TV 101 determines whether the user-selected processing is apparatus registration.

If the TV 101 has determined that the user-selected processing is the apparatus registration (YES in step S1403), the TV 101 proceeds to step S1404. If the TV 101 has determined that the user-selected processing is not the apparatus registration (NO in step S1403), the TV 101 proceeds to step S1408. If the TV 101 has determined that the user-selected processing is not the apparatus registration, the TV 101 determines that the user-selected processing is apparatus registration deletion.

In step S1404, the TV 101 determines whether the number of registered apparatuses in the permanent installation list exceeds a maximum number of registered apparatuses. If the TV 101 has determined that the number of registered apparatuses in the permanent installation list exceeds the maximum number (YES in step S1404), the TV 101 proceeds to step S1407. Alternatively, if the TV 101 has determined that the number of registered apparatuses in the permanent installation list does not exceed the maximum number (NO in step S1404), the TV 101 proceeds to step S1405.

In step S1405, selection of an apparatus (registration apparatus) to be registration causes the TV 101 to acquire information identifying the user-selected apparatus. The user may selects the registration apparatus from presently connected apparatuses, and the TV 101 may store an previously connected apparatuses and may select a registration apparatus from them.

In step S1406, on the basis of the information, the TV 101 registers the user-selected apparatus in the permanent installation list. The process of the TV 101 in FIG. 13 finishes.

In addition, in step S1407, the TV 101 displays a screen in which the number of registered apparatuses in the permanent installation list exceeds the maximum number. The process of the TV 101 in FIG. 13 finishes.

If the TV 101 has determined that the user-selected apparatus is the apparatus registration deletion (N in step S1403), in step S1408, the TV 101 acquires information identifying, from the permanent installation list, the user-selected apparatus, whose registration is to be performed. In step S1409, on the basis of the information, the TV 101 deletes the user-selected apparatus from the permanent installation list. The process of the TV 101 in FIG. 13 finishes.

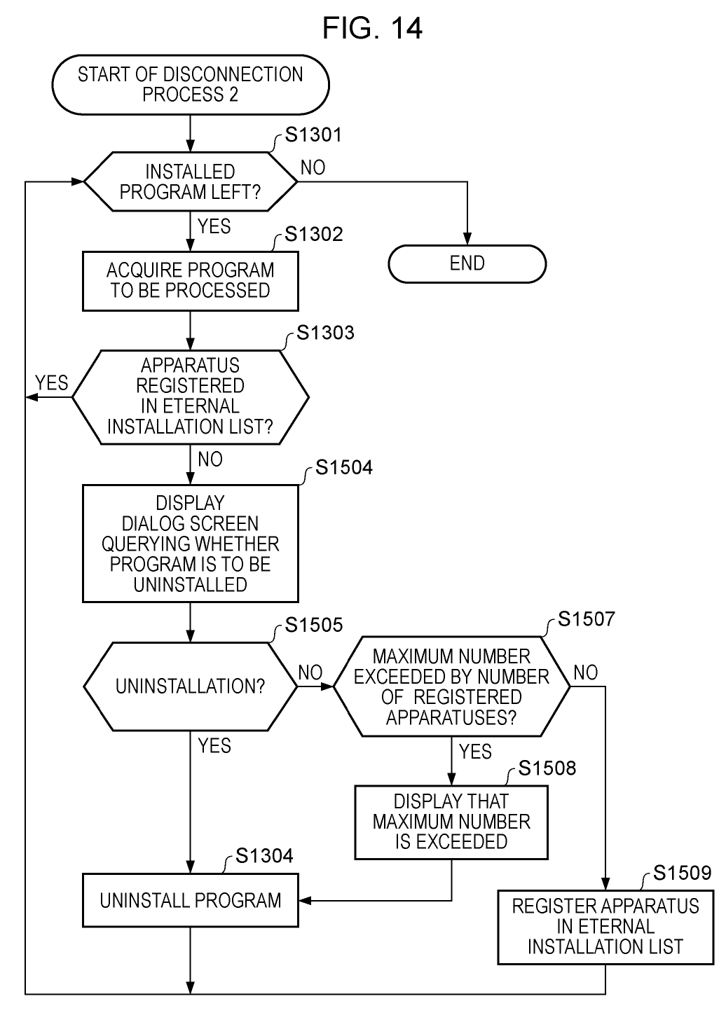

Next, a second disconnection process (indicated by “Disconnection Process”) is described below with reference to the flowchart shown in FIG. 14. FIG. 14 is a flowchart showing an example of the second disconnection process. The flowchart in FIG. 14 is applicable to either the TV 101 or the camera 102. For brevity of description, the TV 101 is used in the following description.

Although, in the processes shown in FIGS. 11 and 12, at the time of installation, it is determined whether the installation is permanent, in the process in FIG. 14, at the time of disconnection, it is determined whether the installation is permanent.

Also in the process in FIG. 14, program registration to the installation list, described in step S1206 in the installation process, has been performed. In the process in FIG. 14, steps S1301 to S1303 are common to FIG. 12. If, in step S1303 in FIG. 14, the TV 101 has determined that the other party apparatus is not registered in the permanent installation list, the TV 101 proceeds to step S1504.

In step S1504, the TV 101 displays, on the display 205, a dialog screen for querying the user about whether uninstallation is to be performed. In step S1505, if a user's response is “to uninstall” (YES in step S1505), the TV 101 determines to perform uninstallation, and proceeds to step S1304. If the user's response is “not to uninstall” (NO in step S1505), the TV 101 determines not to perform uninstallation, and proceeds to step S1507.

In step S1304, the TV 101 uninstalls the program to be uninstalled, and proceeds to step S1301. In step S1507, the TV 101 determines whether the number of registered apparatuses in the permanent installation list of programs to be processed (or being processed) exceeds a predetermined maximum number of registered apparatuses. If the TV 101 has determined that the number of registered apparatuses exceeds the maximum number (YES in step S1507), the TV 101 proceeds to step S1508. Alternatively, if the TV 101 has determined that the number of registered apparatuses does not exceed the maximum number (NO in step S1507), the TV 101 proceeds to step S1509. In step S1508, the TV 101 displays a screen showing that the number of registered apparatuses (in the permanent installation list of the programs to be processed) does exceeds the maximum number, and proceeds to step S1304.

In step S1509, the TV 101 registers, in the permanent installation list of the programs to be processed, the other party apparatus to be disconnected, and proceeds to step S1301.

Each process in the foregoing embodiment can be realized by a program operating on each apparatus although the process needs hardware. Therefore, also in a storage medium storing programs of software realizing the functions in the embodiment, and program code, the above-described functions or processes can be realized by reading and executing the programs and the program code.

In the foregoing embodiment, appropriate software (program or function program) can quickly be installed into two apparatuses connected to each other.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-108805 filed Apr. 11, 2006, which is hereby incorporated by reference herein in its entirety.

What is claimed:

1. A program installation method comprising:
acquiring a first program by a first apparatus on the basis of apparatus information of a second apparatus;
installing the first program into the first apparatus by the first apparatus;
acquiring a second program corresponding to the first program by the first apparatus; and
by the first apparatus, providing the second apparatus with a second program that is installed by the second apparatus.

2. The program installation method according to claim 1, wherein on the basis of program version information of the second apparatus, the first apparatus determines whether to acquire the first program.

3. The program installation method according to claim 1, wherein on the basis of program version information of the first program, the first apparatus determines whether to acquire the second program.

4. A program installation method comprising:
acquiring a first program by a third apparatus on the basis of apparatus information of a second apparatus;
by the third apparatus, providing a first apparatus with the first program, which is installed into the first apparatus;
by the third apparatus, acquiring a second program corresponding to the first program; and
by the third apparatus, providing the first apparatus with the second program, which is installed by the second apparatus.

5. The program installation method according to claim 4, wherein on the basis of program version information of the second apparatus, the third apparatus determines whether to acquire the first program.

6. The program installation method according to claim 4, wherein on the basis of program version information of the first program, the third apparatus determines whether to acquire the second program.

7. A program installation method comprising:
acquiring a first program by a first apparatus on the basis of a function requested by a second apparatus;
installing the first program into the first apparatus by the first apparatus;
by the first apparatus, acquiring a second program corresponding to the first program; and
by the first apparatus, providing the second apparatus with the second program, which is installed by the second program.

8. The program installation method according to claim 7, wherein on the basis of program version information of the second apparatus, the first apparatus determines whether to acquire the first program.

9. The program installation method according to claim 7, wherein on the basis of program version information of the first program, the first apparatus determines whether to acquire the second program.

10. A program installation method comprising:
acquiring a first program by a third apparatus on the basis of a function requested by a second apparatus;
by the third apparatus, providing a first apparatus with the first program, which is installed into the first apparatus;
by the third apparatus, acquiring a second program corresponding to the first program; and
by the third apparatus, providing the first apparatus with the second program, which is installed by the second apparatus.

11. The program installation method according to claim 10, wherein on the basis of program version information of the second apparatus, the third apparatus determines whether to acquire the first program.

12. The program installation method according to claim 10, wherein the third apparatus determines whether to acquire the second program.

13. A program installation apparatus comprising:
an acquisition unit configured to acquire a first program on the basis of apparatus information of a different apparatus and acquire a second program corresponding to the first program;
an installation unit configured to install the first program; and
a provision unit configured to provide the different apparatus with the second program, which is installed by the different apparatus.

14. A program installation apparatus comprising:
an acquisition unit configured to acquire a first program on the basis of apparatus information of a second apparatus and acquire a second program corresponding to the first program; and
a provision unit configured to provide the first program, which is installed into a first apparatus, and provide the first apparatus with the second program, which is installed by the second apparatus.

15. A program installation apparatus comprising:
an acquisition unit configured to acquire a first program on the basis of a function requested by a different apparatus and acquire a second program corresponding to the first program;
an installation unit configured to install the first program; and
a provision unit configured to provide the different apparatus with the second program, which is installed by the different apparatus.

16. A program installation apparatus comprising:
an acquisition unit configured to acquire a first program on the basis of a function requested by a second apparatus and acquire a second program corresponding to the first program; and
a provision unit configured to provide the first apparatus with the first program, which is installed into the first apparatus, and provide the first apparatus with the second program, which is installed by the second apparatus.

17. A computer readable medium containing computer-executable instructions for program installation between a first and second apparatus, the medium comprising:
computer-executable instructions for acquiring a first program on the basis of apparatus information of the second apparatus;
computer-executable instructions for installing the first program in the first apparatus;
computer-executable instructions for acquiring a second program corresponding to the first program; and
computer-executable instructions for providing the second apparatus with the second program, which is installed by the second apparatus.

18. A computer readable medium containing computer-executable instructions for program installation between a first and second apparatus, the medium comprising:
computer-executable instructions for acquiring a first program on the basis of apparatus information of the second apparatus;
computer-executable instructions for providing the first apparatus with the first program, which is installed into the first apparatus;
computer-executable instructions for acquiring a second program corresponding to the first program; and
computer-executable instructions for providing the first apparatus with the second program, which is installed by the second apparatus.

19. A computer readable medium containing computer-executable instructions for program installation between a first and second apparatus, the medium comprising:
computer-executable instructions for acquiring a first program on the basis of a function requested by the second apparatus;
computer-executable instructions for installing the first program into the second apparatus;
computer-executable instructions for acquiring a second program corresponding to the first program; and
computer-executable instructions for providing the second apparatus with the second program, which is installed by the second apparatus.

20. A computer readable medium containing computer-executable instructions for program installation between a first and second apparatus, the medium comprising:
computer-executable instructions for acquiring a first program on the basis of a function requested by the second apparatus;
computer-executable instructions for providing the first apparatus with the first program, which is installed into the first apparatus;
computer-executable instructions for acquiring a second program corresponding to the first program; and
computer-executable instructions for providing the first apparatus with the second program, which is installed by the second apparatus.
